(19) United States
(12) Patent Application Publication
(10) Pub. No.: US 2014/0180791 A1
(43) Pub. Date: Jun. 26, 2014

(54) Method for Optimizing the Delivery of Marketing Offers

(71) Applicants: William Dugan, Overland Park, KS (US); Tim Prier, Overland Park, KS (US)

(72) Inventors: William Dugan, Overland Park, KS (US); Tim Prier, Overland Park, KS (US)

(21) Appl. No.: 13/724,309

(22) Filed: Dec. 21, 2012

(51) Int. Cl. G06Q 30/02

(52) U.S. Cl. CPC G06Q 30/0244
USPC 705/14.43

(57) ABSTRACT

The present invention is directed to a method for optimizing the delivery of marketing offers. In an exemplary embodiment, an initial consumer offer is delivered to a consumer via an email service provider (ESP), that consumer's subsequent response to the initial offer, response information provided by the consumer, and response and tracking data are used to optimize and target additional offers to that same, and other, consumers.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND OF THE INVENTION

1. Field of the Invention

The present invention is generally directed to the field of marketing and, more specifically, to a method for optimizing the delivery of marketing offers in a marketing campaign.

2. Description of Related Art

Every year, the consumer loan and credit card industry provides hundreds of billions of dollars in credit to consumers. Potential consumers seek-out credit opportunities themselves, or respond to opportunities presented to them in various marketing contexts, including email, Internet, postal mail, and the like. Targeted advertising and marketing is known in the art, particularly email advertising sent directly to consumers. While the costs associated with Internet and email delivery of marketing offers are low compared to conventional postal direct mailing, the cost of obtaining leads for potential consumers can be substantial. Because of the costs involved, lenders and other marketers desire high-quality leads, i.e., leads that can be converted into customers. Bulk lists of consumer names and contact information often contain stale or outdated leads, and have no mechanism for comparing or tracking the effectiveness of either the consumer or the marketing offer sent to the consumers. Thus, there remains a need in the art for method that improves the effectiveness of marketing offers.

### BRIEF SUMMARY OF THE INVENTION

The present invention is directed to a method for optimizing the delivery of marketing offers by targeting, tracking, and optimizing marketing offers in the course of a marketing campaign. In an exemplary embodiment, an initial marketing offer is presented to a plurality of consumers. Those consumers' subsequent responses to the initial offer, information provided by the consumers and information provided by the email service providers (ESPs) used to deliver the offers, are used to optimize and target subsequent offers to those consumers. The information obtained may also be used in future or additional marketing campaigns to target additional offers to the same, or other, consumers.

Consumer responses, i.e., “triggers”, to the various offers are tracked and analyzed, and used to generate additional offers to the same consumer, or to other consumers or groups of consumers based on particular consumer information, such as similar demographic, income, or interests expressed by the consumer.

In one exemplary embodiment, a marketing campaign comprising a plurality of offers is delivered by one or more email service providers (ESP's) to a plurality of consumers. The initial offer to each of the consumers may come from a consumer request—e.g., a consumer navigates to a website and applies for an offered consumer loan where the consumer information is captured, or the consumer may have responded to a previous marketing campaign. In either case, a marketing campaign delivers a plurality of offers to a plurality of consumers. The offers sent to each consumer may be identical, or the offers may vary in appearance, may vary in the terms and/or product offered.

Information regarding the marketing campaign, including the specific offers sent to each consumer and the ESP used to deliver the offer is tracked. Likewise, each ESP tracks consumer response to the offer, including engagement rates (i.e., rate of consumers responding to the offer), deliverability of offers, and other information provided by the consumer in response to the offer.

Using the gathered information, the marketing campaign is optimized, and additional offers are targeted and sent based upon the information gathered from the initial offer. Preferably, the optimization is performed in real-time, with subsequent offers sent based upon consumer responses to previously sent offers. For example, an additional offer for an up-sell or cross-sell product may be sent to the consumers who expressed interest in the initial offer or otherwise reacted to the initial offer. In addition to consumer information, tracking of the response of offers sent via each ESP allows selection and optimization of subsequent offers to a specific ESP (or specific group of ESPs), such that an ESP having a low response rate to an initial offer may be dropped from subsequent offers in the marketing campaign. Thus, the targeting, tracking, and optimization of a marketing campaign can be accomplished in real-time by iteratively offering and tracking consumer and ESP response information, and refining and optimizing additional offers and/or campaigns.

It should be understood that while the claimed invention is described primarily with reference to an exemplary marketing campaign offered primarily via email through ESPs, the same targeting, tracking, and optimization may be employed in marketing campaigns conducted via text message, telephone, postal, or other delivery mediums and methods. It should also be understood that while the described invention may perform the optimization in real-time in response to tracked Internet and email offers, the same optimization may also be performed in a delayed manner, for example, in a direct mail campaign where consumer response is not necessarily available in real time. These and other variations are contemplated by the present invention and are within the scope of the claims.

Likewise, it should be understood that while the claimed invention is described with reference to a marketing campaign directed to consumer credit (e.g., consumer loans, credit cards, and the like), that the invention is equally applicable to other vertical markets, such as insurance, mortgage, and auto loans. These and other variations are contemplated by and are within the scope of the present invention.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 is a diagram of an exemplary implementation of the method of the present invention.

FIG. 2 is a flow diagram of an exemplary optimization process in accordance with the present invention.

### DETAILED DESCRIPTION OF EXEMPLARY EMBODIMENTS

The present invention is directed to a method for targeting, tracking, and optimizing the delivery of marketing offers, such as offers in the course of a marketing campaign. While the method will be described herein will be described with reference to an exemplary use in the consumer loan area, it should be understood that the claimed method is not limited to that area, and may equally be employed in auto loan or other lending services, credit card, and any other vertical markets in which consumers are targeted with marketing offers.

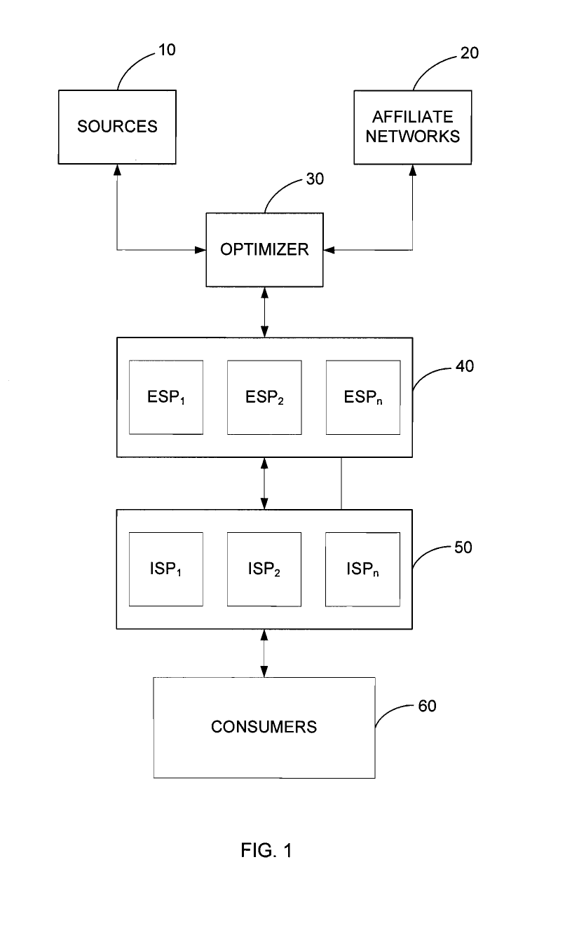

Referring first to FIG. 1, an exemplary implementation of the method of the present invention is depicted. As seen at block 10, sources of consumer data (i.e., lists of potential consumers) are provided to optimizer 30. Data sources 10 are typically lead generation and mailing list providers which have compiled consumer lists of contact information for consumers who have expressed interest in a particular product, typically by visiting a website offering, for example, a consumer loan product. The offering website typically gathers consumer contact information and requests consent or opt-in from the consumer to receive marketing from third parties, making their information available on a consumer list.

As seen at block 20, affiliate networks similarly provide marketing offers to the optimizer 30. Affiliate networks typically are affiliated with a group of lenders, each of which are interested in providing advertising or other marketing offers to consumers. Alternatively, the affiliate network may be a single direct lender interested in providing a marketing offer. The marketing may consist of a single offer intended to be offered to a specific demographic of consumers, or, more typically, may be a marketing campaign comprising multiple offers to be targeted in an optimized manner to consumers based on various gathered statistical information as will be discussed in more detail below.

Optimizer 30 is preferably a processor, server, or group of processors and/or servers operable to communicate over a network to the sources 10 and affiliate networks 20. Any type of network known in the art may be used to network the sources 20 and affiliate networks to the optimizer 30. For example, the network may be a local area network (LAN), wireless local area network (WLAN) or wide area network (WAN), or may be connected via a communication network including any combination of analog, digital, wired and wireless communication equipment and infrastructure suitable for transporting information between processors and/or servers at each location. For example, the communication network may include one or more of the following: the Internet, an intranet, a cellular communication system, a Public Switched Telephone Network (PSTN), a private telephone network, or a satellite communication system. The communication network may be either an open or closed network, or may include numerous paths of any combination thereof.

Looking still to FIG. 1, optimizer 30 (the details of which will be discussed below) is in communication with one more email service providers (ESPs) 40. ESPs 40 may comprise any number of individual email service providers, as indicated in the figure as ESP₁, ESP₂ through ESPₙ. Communication between optimizer 30 and the ESPs is preferably over a communication network as previously described. In operation and as will be described in more detail below, optimizer 30 selects and provides both a consumer contact information (from the consumer lists provided by the sources) and a selected advertising offer to one or more of the email service providers. The email service providers are preferably commercial providers offering bulk email services capable of sending and tracking emails over a network (i.e., the Internet) to an entire list of recipients in HTML, plain text, and other formats known in the art. As shown at block 40, multiple ESPs may be employed, each having varying targeting and tracking methodologies, with each preferably able to provide tracking, deliverability, response information back to optimizer 30, either directly or indirectly, for each message sent. For example, each ESP is preferably able to report back any undeliverable emails so that those email addresses may be culled from the data source list, and preferably provides information as to whether an email was received, opened, and/or if a link provided in the email was viewed or clicked by the recipient.

Looking to block 50, each ESP is preferably in communication with, and sends emails via, various Internet Service Providers or ISPs, such as Google/Gmail, Yahoo, AOL, and others known in the art. ISPs 50 may comprise any number of individual email service providers, as indicated in the figure as ISP₁, ISP₂ through ISPₙ.The ISPs provide delivery of email to the users of their respective services. ISPs 50 are preferably in communication with the ESPs via communications network as previously described.

Turning to block 60, the targeted consumers receive emails (and the marketing offer) through their ISPs. The consumers 60 are preferably in communication with the ISPs over a communications network as previously described. Upon receipt of the email (or the undeliverability thereof), tracking information propagates back through the ISPs and ESPs to the optimizer 30 so that tracking information with respect to the deliverability of the email can be considered in the optimization and selection of additional offers to be sent to the consumer. In addition to the tracking information provided by the ESP, the optimizer 30 receives responses or “trigger” information from the ESP and/or the affiliate network with respect to a consumer's response to a particular advertisement or offer.

Optimizer 30 preferably comprises a computing system (such as a programmed general purpose computer, a server, a special purpose computer, or the like) that includes a processor and a storage device for storing the consumer lists, marketing offers, and tracking and response information gathered in the course of the marketing campaign. The processor of optimizer 30 is operable to execute computer-readable instructions (e.g., software or firmware) stored on a computer-readable medium (e.g., the computer's internal hard drive, a thumb drive or a compact flash card) to thereby perform the various processes of the present invention. The storage device of optimizer 30 may comprise any type of computer memory, such as the computer's internal hard drive, a thumb drive or a compact flash card. One skilled in the art will appreciate that other types of memory devices may also be used in accordance with the present invention.

Optimizer 30 gathers and reviews tracking and response data from consumers and ESPs, and optimizes subsequent marketing offers based on that data. For example, the optimizer tracks engagement rates (e.g., what offers triggered consumer reaction), along with tracking and deliverability of offers. Alternatively, the network affiliates may provide engagement rate data for particular offers. In response to the gathered data, optimizer 30 targets delivery of subsequent offers. For example, based on consumer triggers or reaction to a particular marketing offer, optimizer 30 may provide an up-sell offer (i.e., an improved but similar offer) or a cross-sell offer (i.e., a different but related offer). In addition, optimizer 30 reviews ESP data and may select or exclude ESPs for delivery of subsequent offers. For example, and ESP with lower engagement rates of consumers, or high undeliverable rates, may be excluded from delivery of subsequent offers.

Furthermore, optimizer 30 may provide optimization based on ESP and consumer data, thus taking into account a particular consumer's (or group of consumers') responses along with ESP performance to direct subsequent marketing offers. Thus, the optimizer provides for robust, adaptable targeting of subsequent marketing offers. Preferably consumer trigger and ESP engagement rate data is provided in real-time to optimizer 30 so that subsequent marketing offers in a marketing campaign can be timely delivered to interested consumers through ESPs that have been proven reliable to deliver to those consumers. It should be understood that the optimizer is a dynamic process, and that tracking and responses to subsequent offers will be incorporated into the optimizer to provide ongoing dynamic adjustability to targeting further marketing offers.

It should also be understood that the optimizer may be employed for use with delivery of a series of offers, and based on consumer response and ESP data, subsequent delivery will focus on those offers that received consumer response, dynamically eliminating offers for which response was poor. Optimizer 30 may also alter the frequency of sending offers based on the tracking data, increasing the frequency of delivery of offers that triggered responses and decreasing the delivery of offers that did not receive responses. Or, optimizer 30 may manage and optimize an entire marketing campaign, for example an offer comprising twenty different ads having five different loading pages, tracking consumer and ESP response data and focusing and increasing delivery of offers that are performing at a higher rate (and eliminating those with lower rate responses). Optimizer 30 can be used to focus on any desired parameter, such as conversion rate or revenue for a particular offer, or, more typically, will consider a combination of parameters in targeting delivery of subsequent offers.

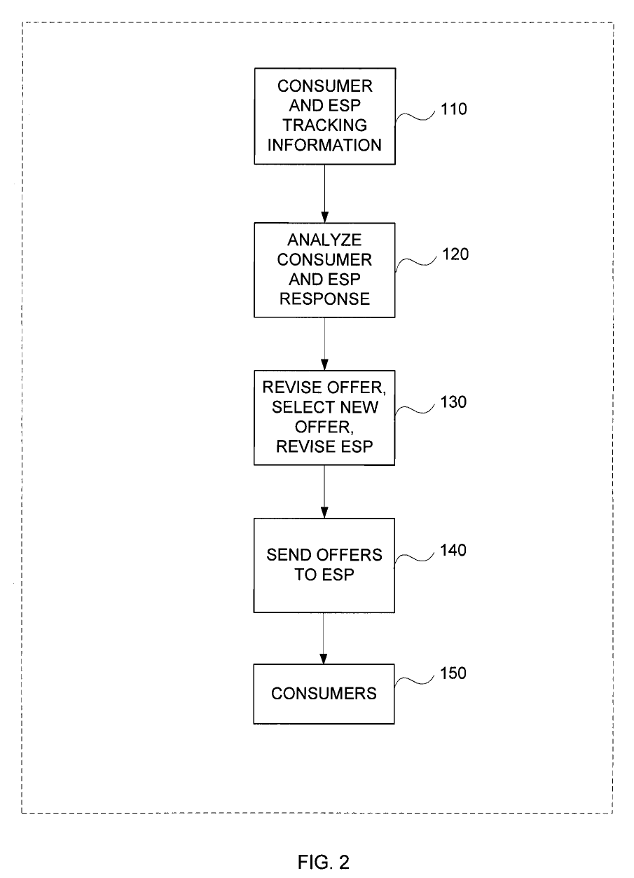

Operation of an exemplary embodiment of the claimed invention will now be described in conjunction with FIG. 2. It should be understood that FIG. 2 describes an exemplary optimization process (as described generally above) wherein an initial trigger or response has been acquired from a prior marketing offer. At block 110, consumer and ESP tracking information 110 has been acquired in response to a previously sent marketing offer. At block 120 both the consumer and ESP data is analyzed.

At block 130, an optimized delivery strategy for subsequent offers is performed. As described previously, the engagement rates and deliverability for offers delivered through particular ESPs is reviewed, and a particular ESP (or group of ESPs) is selected for delivering the subsequent offer. In addition, consumer responses to the previous offer may be considered in selecting a subsequent offer of an up-sell or cross-sell offer. Preferably, the subsequent offer is targeted based on both the consumer and ESP response and tracking data. As discussed above, the subsequent offer may be an up-sell or cross-sell offer, or it may be a part of a series of offers offered in a marketing campaign and that, depending on consumer response and ESP data, subsequent offers will focus on those offers that received consumer response, dynamically eliminating offers for which response was poor. Or, the frequency of sending offers based on the tracking data may be varied. As also discussed, the selection of the subsequent offer may be based on an entire marketing campaign, having for example twenty different ads having five different loading pages, with the consumer and ESP response data used to select subsequent marketing offers. It should be understood that the optimization can be based on any or all of these variations and parameters, or combinations thereof.

Finally, with the subsequent offers sent to consumers at block 150, it should be understood that the optimization iterates, that is, the subsequent offer will likewise generate tracking and response data from consumers and ESPs that feeds into the optimizer at block 110. That data, in turn, is used to select yet another subsequent offer which generates additional information. Thus, it can be seen that the method of the present invention provides a dynamic, robust and adaptable method for optimizing the delivery of marketing offers.

It should be understood that while the claimed invention is described primarily with reference to an exemplary marketing campaign offered primarily through ESPs, the same targeting, tracking, and optimization may be employed in marketing campaigns conducted via text message, telephone, postal, or other delivery mediums and methods

Likewise, it should be understood that while the claimed invention is described with reference to a marketing campaign directed to consumer credit (e.g., consumer loans, credit cards, and the like), that the invention is equally applicable to other vertical markets, such as insurance, mortgage, and auto loans. These and other variations are contemplated by and are within the scope of the present invention.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

The present invention has been described above with reference to the terms “processor,” “storage device” and “database.” It should be understood that as used herein (including in the claims) the term “processor” may mean either a single processor that performs the described processes or a plurality of processors that collectively perform the described processes; the term “storage device” means either a single storage device that stores the described database(s) or a plurality of storage devices that collectively store the described database(s); and the term “database” means either a single database that contains the described data or a plurality of databases that collectively contain the described data. Thus, the system and method may be implemented with any number of processor(s), storage device(s) and database(s) without departing from the scope of the present invention.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

what is claimed and desired to be secured by Letters Patent is as follows:

1. A computer-implemented method for optimizing delivery of marketing offers, comprising:
receiving a source list comprising contact information for a plurality of consumers;
receiving at least one marketing offer comprising an offer of goods or services to a consumer;
using at least one processor to:
perform optimization of a delivery scheme by analyzing response and tracking information to target said advertising offer to at least one of said plurality of consumers;
sending said marketing offer via at least one of a plurality of email service providers to at least one of said plurality of consumers based on said optimization; and
receiving response and tracking information related to said sent marketing offer.

2. The computer-implemented method of claim 1, wherein said optimization comprises selecting at least one email service provider based on tracked performance of said plurality of email service providers.

3. The computer-implemented method of claim 1, wherein said optimization comprises selecting a marketing offer based on tracked consumer responses to previously sent marketing offers.

4. The computer-implemented method of claim 1, wherein said optimization comprises selecting at least one email service provider based on tracked performance of said plurality of email service providers and selecting a marketing offer based on tracked consumer responses to previously sent marketing offers.

5. The computer-implemented method of claim 1, wherein said email service provider transmits said marketing offer through at least on Internet Service Provider.

6. The computer-implemented method of claim 1, wherein said optimization comprises analyzing responses from consumers to previously-sent marketing offers.

7. The computer-implemented method of claim 6, further comprising:
sending a subsequent marketing offer based on said responses from consumers to said previously sent marketing offers.

8. The computer-implemented method of claim 1, wherein said marketing offer comprises an offer of goods or services in the field of consumer loans, installment loans, insurance, credit cards, and mortgages.

9. The computer-implemented method of claim 1, wherein said response and tracking information is stored to a non-transient computer readable medium.

10. The computer-implemented method of claim 1, wherein at least a portion of said response information is provided by an originator of said marketing offer.

11. The computer-implemented method of claim 1, wherein said optimization comprises analysis of conversion rates and revenue values of previously sent marketing offers.

12. The computer-implemented method of claim 1, wherein said sending step comprises sending said advertising offer via text message, telephone, or postal service.

13. The computer-implemented method of claim 1, wherein said contact information is received in real-time response to a previously sent marketing offer.

14. The computer-implemented method of claim 1, wherein said optimization step is performed in real-time in response to receipt of said response and tracking information.

15. The computer-implemented method of claim 1, wherein said optimization comprises analysis of consumer demographics.

16. A computer-readable medium having instructions stored thereon for execution by a processor to perform a method for optimizing delivery of marketing offers, the method comprising:
receiving a source list comprising contact information for a plurality of consumers;
receiving at least one marketing offer comprising an offer of goods or services to a consumer;
optimizing a delivery strategy by analyzing response and tracking information to target said advertising offer to at least one of said plurality of consumers;
sending said marketing offer via at least one of a plurality of email service providers to at least one of said plurality of consumers based on said optimization; and
receiving response and tracking information related to said sent marketing offer.

17. The computer-readable medium of claim 16, wherein said optimizing comprises selecting at least one email service provider based on tracked performance of said plurality of email service providers.

18. The computer-readable medium of claim 16, wherein said optimizing comprises selecting a marketing offer based on tracked consumer responses to previously sent marketing offers.

19. The computer-readable medium of claim 16, wherein said optimizing comprises selecting at least one email service provider based on tracked performance of said plurality of email service providers and selecting a marketing offer based on tracked consumer responses to previously sent marketing offers.

20. The computer-readable medium of claim 16, wherein said email service provider transmits said marketing offer through at least one Internet Service Provider.

21. The computer-readable medium of claim 16, wherein said optimizing comprises analyzing responses from consumers to previously-sent marketing offers.

22. The computer-readable medium of claim 16, wherein the method further comprises:
sending a subsequent marketing offer based on said responses from consumers to said previously sent marketing offers.

23. The computer-readable medium of claim 16, wherein said marketing offer comprises an offer of goods or services in the field of consumer loans, installment loans, insurance, credit cards, and mortgages.

24. The computer-readable medium of claim 16, wherein said response and tracking information is provided by an email service provider.

25. The computer-readable medium of claim 16, wherein said response information is provided by an originator of said marketing offer.

26. The computer-readable medium of claim 16, wherein said optimization comprises analysis of conversion rates and revenue values of previously sent marketing offers.

27. The computer-readable medium of claim 16, wherein said sending step comprises sending said advertising offer via text message, telephone, or postal service.

28. The computer-readable medium of claim 16, wherein said contact information is received in real-time response to a previously sent marketing offer.

29. The computer-readable medium of claim 16, wherein said optimizing comprises analysis of consumer demographics.

30. The computer-readable medium of claim 16, wherein said optimizing step is performed in real-time in response to receipt of said response and tracking information.
